(19) United States
(12) Patent Application Publication
(10) Pub. No.: US 2012/0240640 A1
(43) Pub. Date: Sep. 27, 2012

(54) SECURITY NUT AND TOOL

(76) Inventors: THOMAS DIAZ, Miami, FL (US); LEONARDO F. LOPEZ, Palmetto Bay, FL (US)

(21) Appl. No.: 13/069,314

(22) Filed: Mar. 22, 2011

(51) Int. Cl. E05B 73/00

(52) U.S. Cl. 70/58

(57) ABSTRACT

A security device, comprising, a bolt, comprising, a head, wherein the head comprises at least one functional marker; and a hollow cylinder, the hollow cylinder comprising a bolt internal threaded surface and a bolt external threaded surface, wherein the bolt internal threaded surface extends through the head; and a nut, comprising, a first nut cylinder, wherein the first nut cylinder is internally grooved threaded and of the same diameter as the bolt external threaded surface; and a second nut cylinder, whereby the second nut cylinder is capable of containing the head of the bolt when the bolt external threaded surface is securely screwed into the first nut cylinder. A bolt, the bolt further comprising at least one functional marker, and where the bolt is externally threaded in reverse. A nut, where the nut internal grooves threaded in reverse; and a key; wherein the key comprises a receiving unit, wherein the receiving unit comprises at least one functional interaction point, whereby the at least one functional marker of the head of the bolt and the at least one functional interaction point of the key match up and allow for the key to engage the head.

### FIELD OF THE INVENTION

The present invention relates to the art of theft-prevention and security devices.

### STATEMENT REGARDING FEDERALLY-SPONSORED RESEARCH AND DEVELOPMENT

Not applicable.

### BACKGROUND OF THE INVENTION

Machines, bicycles, canoes, cars, motorcycles, boats, trailers, are expensive are expensive items that must be left unattended in public places. It only makes sense to protect them in every way possible from theft. Theft-prevention devices deter thieves from attempting to steal your items. Regardless of the value or age of your items, the installation of a theft-prevention device is typically a wise choice. However, sometimes installing alarms, or electronic devices, do not deter the thieves. These devices do not prevent from the physical taking of the items. Merely the sound of an alarm warns the owner for him to react but by the time he does the item is gone.

One out of every four cyclists have had their bicycle stolen during their lifetime. Nonetheless, last year, according to FBI statistics, some 221,000 bicycles were stolen, though it's unlikely that that such stats capture the full scope of the problem.

Furthermore, most security devices are cumbersome and not easily carried by a user, resulting in the proper security not being taken in all instances. As such, there is a need for a theft-prevention, or security device, that is easy to use and adaptable to a user's needs to insure the likelihood that the device will be utilized.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1A depicts at least one embodiment of the invention, namely a side view of a security device.

FIG. 1B depicts at least one embodiment of the invention, namely a cross-sectional view of the security device depicted in FIG. 1A.

FIG. 2 depicts at least one embodiment of the invention, namely a top view of a security device.

FIG. 3 depicts at least one embodiment of the invention, namely a cross-sectional view of a security device.

FIG. 4 depicts at least one embodiment of the invention, namely a cross-sectional view of a security device.

FIG. 5 depicts at least one embodiment of the invention, namely a detailed view of an embodiment of a security device.

FIG. 6 depicts at least one embodiment of the invention, namely a detailed view of an embodiment of a security device at various angles.

FIG. 7 depicts at least one embodiment of the invention, namely a detailed view of an embodiment of a security device at various angles.

### DESCRIPTION OF THE INVENTION

The present invention depicts an inventive solution to the fore mentioned issues related to security devices.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, or should be understood to have the same meaning as “and/or” as defined above. For example, when separating items in a list, or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term or as used herein shall only be interpreted as indicating exclusive alternatives (i.e. one or the other but not both“) when preceded by terms of exclusivity, such as “either,” one of,” “only one of,” or “exactly one of.” “Consisting essentially of,” when used in the claims, shall have its ordinary meaning as used in the field of patent law.

As used herein, the terms “fixably attached” may refer to the attachment of something by way of screwing, bolting, soldering, welding, nailing, or combinations thereof.

The present invention pertains to a security device comprising a bolt and a nut. The bolt comprises a head and a hollow cylinder, wherein the head has additional functional markers for matching up with a locking device. The nut comprises two cylinders for interconnection with the bolt.

In at least one embodiment, the present invention pertains to a security device, comprising a bolt, the bolt including a head, wherein the head comprises at least one functional marker; and a hollow cylinder, the hollow cylinder comprising a bolt internal threaded surface and a bolt external threaded surface, wherein the bolt internal threaded surface extends through the head. The security device also includes a nut, the nut comprising a first nut cylinder, wherein the first nut cylinder is internally threaded and of the same diameter as the bolt external threaded surface; and a second nut cylinder, whereby the second nut cylinder is capable of containing the head of the bolt when the bolt external threaded surface is securely screwed into the first nut cylinder. In some embodiments, the at least one functional marker may include a pin. In other embodiments, the at least one functional marker may include a groove. In other embodiments, the at least one functional marker may include a combination of pins and grooves.

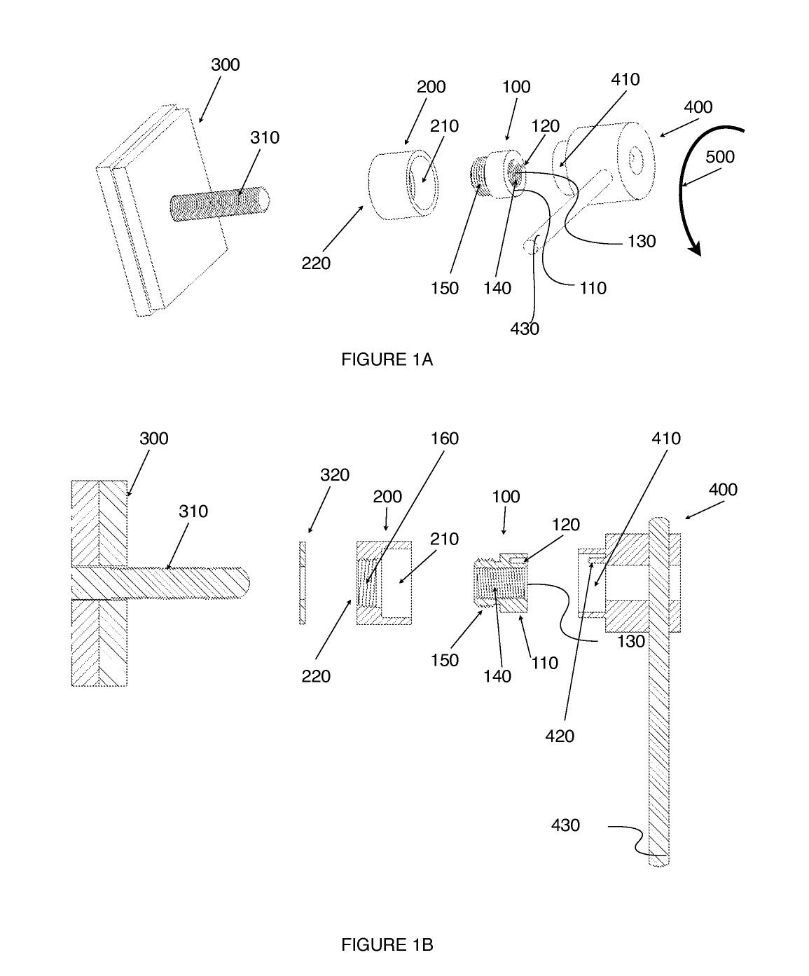

Referring now to the drawings in detail, in FIG. 1A and FIG. 1B, a security device is depicted, the device comprising a bolt 100, the bolt 100 further comprising a head 110, wherein the head 110 comprises at least one functional marker 120; and a hollow cylinder 130, the hollow cylinder 130 comprising a bolt internal threaded surface 140 and a bolt external threaded surface 150, wherein the bolt internal threaded surface 140 extends through the head 110; and a nut 200, comprising a first nut cylinder 210, wherein the first nut cylinder 210 is internally grooved threaded surface 160 and of the matching diameter as the bolt external threaded surface 150; and a second nut cylinder 220, whereby the second nut cylinder 220 is capable of containing the head 110 of the bolt 100 when the bolt external threaded surface 150 is securely screwed into the first nut cylinder 210.

In at least one preferred embodiment, the bolt external threaded surface 150, is threaded in reverse i.e., counterclockwise as shown in 500. The nut internal grooved threaded surface 160, is threaded in reverse to properly mate the bolt external threaded surface 150. This way of threading the bolt and nut, is made counter to the standard nut and bolt threads thus adding an extra security feature to the invention herein. It is known in the art that a regularly (clockwise) threaded nut bolt combination herein will function in the same way to achieve the same result. Nevertheless, counterclockwise 500 turning is counter intuitive to a thief and will cause frustration, delay and ultimately prevent the removal of the inventive nut bolt combination herein.

In some embodiments, the security device may include a base 300 and a cylindrical shaft 310, wherein the cylindrical shaft 310 is threaded around its perimeter and fixably attached to the base 300. Such a configuration allows for the bolt internal threaded surface 140 to accept the cylindrical shaft 310 by way of screwing the bolt 100 into place along the cylindrical shaft 310. As would be understood by those skilled in the art, the base could also be in any shape or form that allows for the security device to properly lock the property to be safeguarded in place. As would be understood by those skilled in the art, the “base” could include things such as a chain, a portion of a bike or motorcycle (for example, the device could function to lock a wheel onto a bicycle or motorcycle), a bike rack in a public place or things of a similar nature. Such items could be completely separate from the security device described herein. The possibilities for such a wide variety of bases exists because the base itself only needs to include a threaded shaft to allow the locking portions of the device to interact and lock one's precious property in place.

In some embodiments, the device includes a key 400. The key 400 comprises a receiving unit 410 and the receiving unit 410 may consist of at least one functional interaction point 420. The at least one functional marker 120 of the head 110 of the bolt 100 and the at least one functional interaction point 420 of the key 400 match up and allow for the key 400 to engage the head 110. Such engagement would only occur if the pins and/or grooves of the at least one functional interaction point 420 and at least one functional marker 120 properly line up and contain the correct combination of grooves and/or pins.

In some embodiments, the key 400 may also include a leveraging bar 430. Such a leveraging bar would allow one to apply pressure to the bar 430 while the functional marker 120 and functional interaction point 420 engage and allow for the turning the bolt head 110.

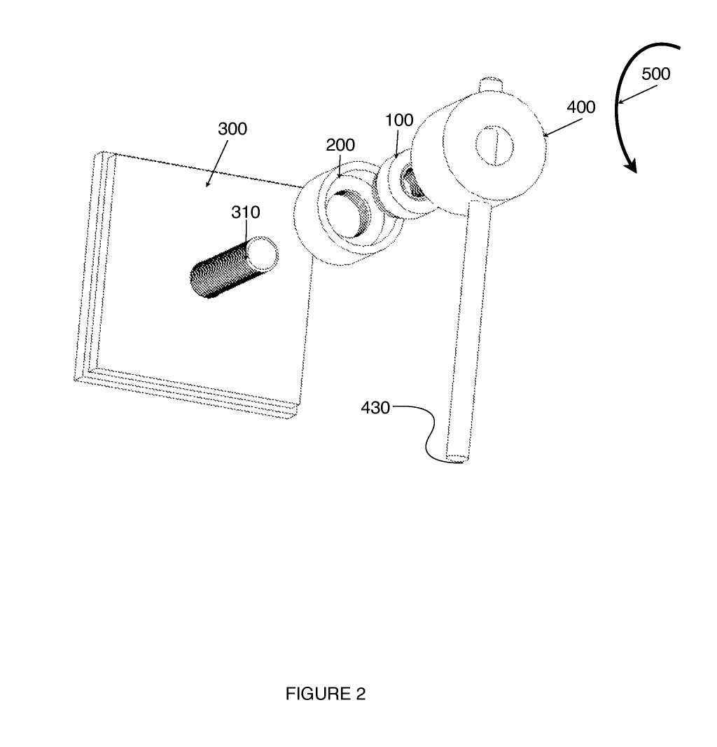

Referring to FIG. 2, an embodiment of the security device is shown wherein the bolt 100 and nut 200 are lined up to be inserted onto the shaft 310 of a base 300. As shown in the embodiment, a key 400 is positioned ready to be inserted and interact with the head of the bolt. In the embodiment depicted, a leveraging bar 430 is included on the key 400. As would be understood by those skilled in the art, other embodiments of the key 400 could include various formations of a leveraging bar 430 or not include one at all. The key 400 could include horizontal or vertically placed leveraging bars. Furthermore, the leveraging bar 430 could be removable. By allowing the leveraging bar 430 to be removable, a single leveraging bar 430 could be utilized for multiple variations of the key 400 (i.e. variations to accommodate further variations of the at least one functional interaction point 420). Likewise, the key could have an adaptation for mechanical or electrical tools to provide the leverage to rotate the bolt 100 once engaged by the key 400. Again, counterclockwise 500 turning will ultimately prevent the removal of the inventive nut bolt combination herein.

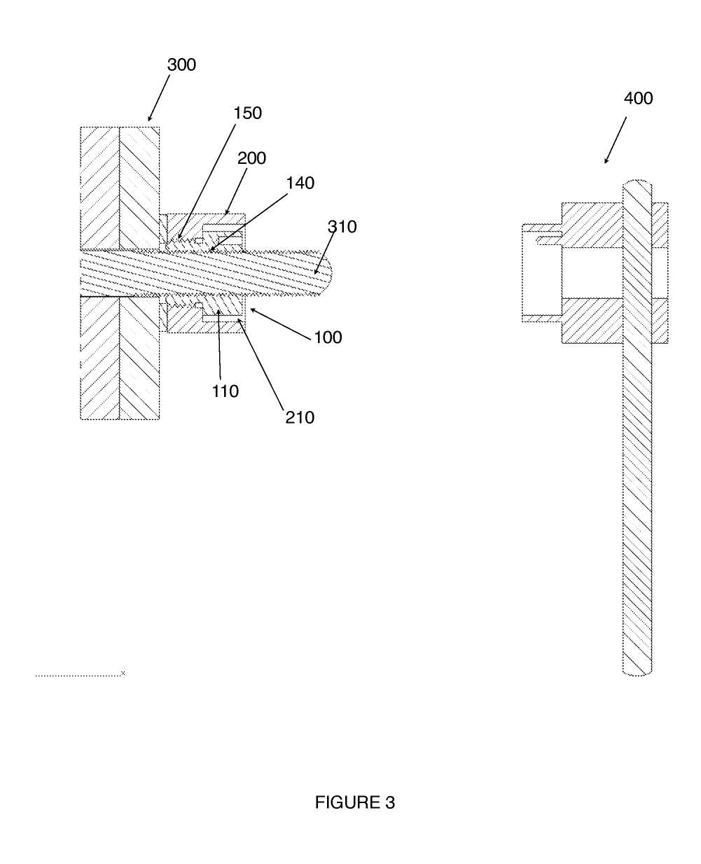

Referring to FIG. 3, an embodiment of the security device is shown wherein the nut 200 and bolt 100 are completely engaged with the shaft 310 of a base 300. As shown in this embodiment, the bolt 100 is screwed onto the shaft 310 by way of the bolt internal threaded surface 140 in while the nut 200 is secured by way of the bolt external threaded surface 150 coupled to internally grooved threaded surface 160. As shown in this embodiment, there is space maintained between the head 110 of the bolt 100 and the second nut cylinder 220 to allow for insertion and rotation of a key 400.

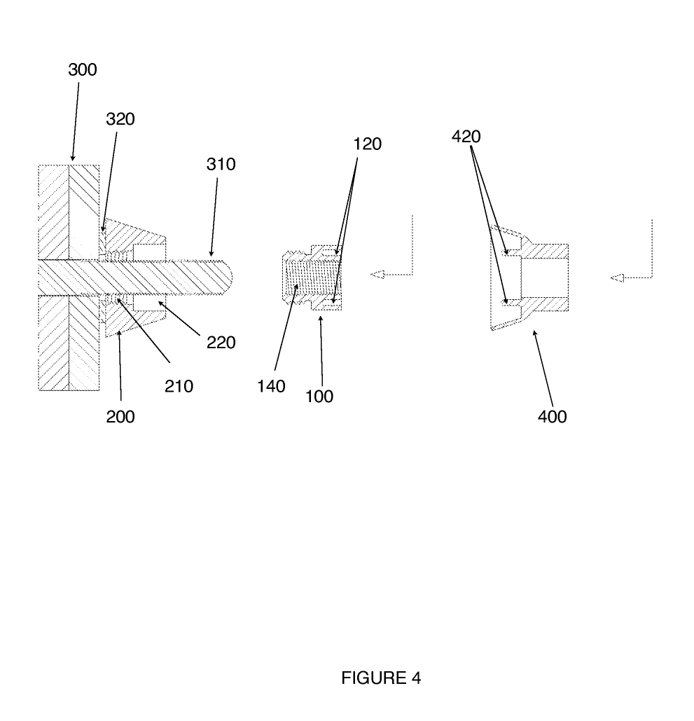

Referring to FIG. 4, an embodiment of the security device is shown wherein the nut 200 is placed into position prior to the bolt 100 being screwed onto the shaft 310 of a base 300. As shown in this embodiment, the nut 200 is placed against the base 300 via a washer 320 such that the shaft 310 extends through the nut 200 via the first nut cylinder 210 and the second nut cylinder 220. The first nut cylinder 210 has internally threaded grooved surface threaded in reverse i.e., counterclockwise. However, the nut 200 does not screw onto the shaft 310. The final securing step occurs when the bolt 100 is threaded onto the shaft 310 via the bolt internal threaded surface 140 and then, finally, when the bolt 100 is threaded into the first nut cylinder 210. The nut 200, in this embodiment comprises a slanted, pyramid shaped cross-section. This is to make gripping tools slide therefore preventing a thief from unlocking the nut 200. Any kind of angle of surface of the nut 200 can be used for the same purpose to achieve the same functional result.

As shown in this embodiment of FIG. 4, the head 110 of the bolt 100 contains more than one functional marker 120. Likewise, a portion of a key 400 is shown wherein multiple functional interaction points 420 are included. In the embodiment depicted, the key 400 is adapted to fit over the nut, instead of within the second nut cylinder 220, to allow for insertion and rotation of a key 400. The shape of the nut is adapted to correspond with the shape of the key 400 such that the key 400 can slip over the nut.

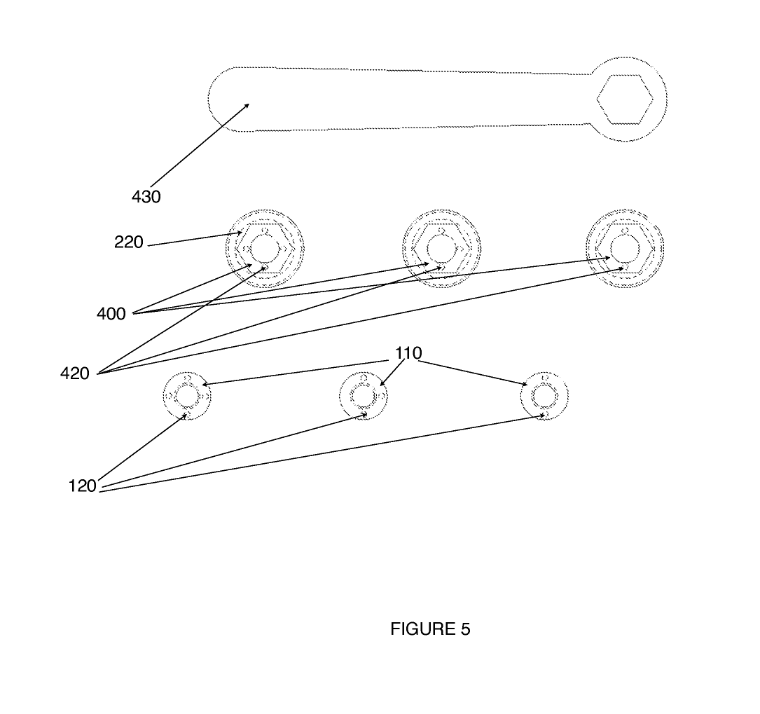

Referring to FIG. 5, an embodiment of the security device is shown wherein several variations of embodiments of a key 400 are shown. In the embodiment depicted, a single, removable leveraging bar 430 is utilized. The leveraging bar is shaped at one end to accommodate the shape of the key 400, wherein it will attach. Likewise, the shape of the key 400 is maintained such that it can still freely fit within the second nut cylinder 220 without engaging the nut 200 via the second nut cylinder 220. As would be understood by those skilled in the art, the key 400 could be adapted to fit over the nut 200, without engaging the nut 200, as shown in FIG. 4. As shown, the key 400 can have various combinations of functional interaction points 420 and still utilize a single leveraging bar 430 that is removable. Also shown are various combinations of functional markers 120 on the head 110 of a bolt. As would be understood by those skilled in the art, the functional markers 120 and functional interaction points 420 could include any combination and/or quantity of grooves, indentions, pins, unique surface formations, etc. as long as the correct combination on the head 110 of a bolt functionally match with the respective key 400.

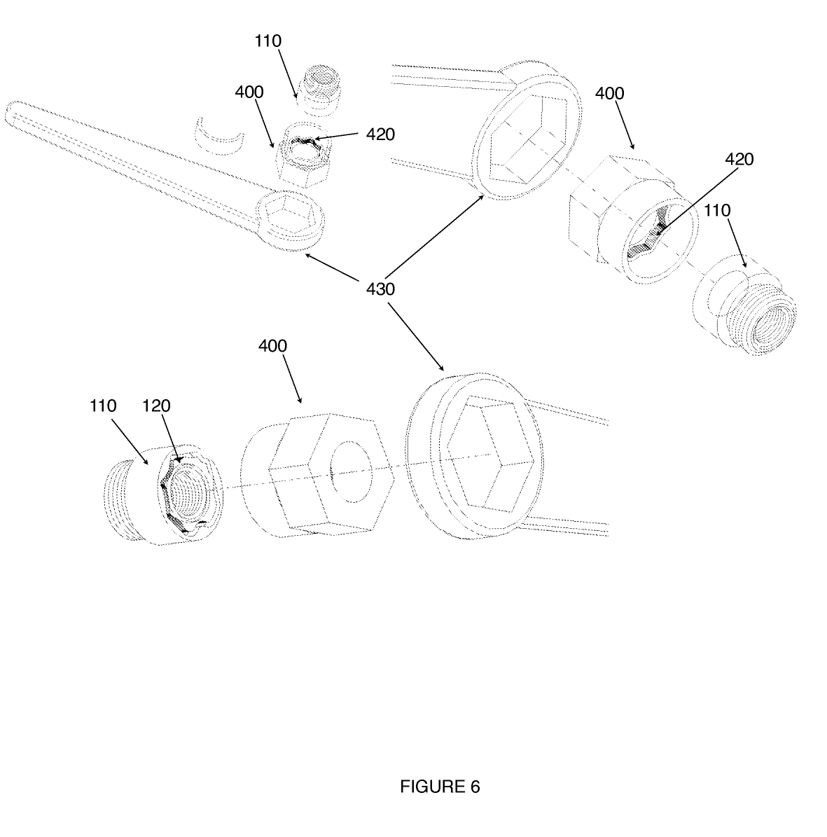

Referring to FIG. 6, an embodiment of the security device is shown wherein an embodiment of a key 400 and corresponding head 110 of a bolt are depicted at different angles. In the embodiment depicted, a single, removable leveraging bar 430 is utilized. The leveraging bar 430 is shaped at one end to accommodate the shape of the key 400, wherein it will attach. The attachment of the key 400 to the leveraging bar 430 could be by any method as would be understood by those skilled in the art. As shown, the key 400 can have various combinations of functional interaction points 420 and still utilize a single leveraging bar 430 that is removable. Also shown is a variation of a functional marker 120 on the head 110 of a bolt that is adapted to engage the functional interaction point 420 of the key 400. As would be understood by those skilled in the art, the functional markers 120 and functional interaction points 420 could include any combination and/or quantity of unique shape grooves, indentions, pins, unique surface formations, etc. as long as the correct combination on the head 110 of a bolt functionally match with the respective key 400.

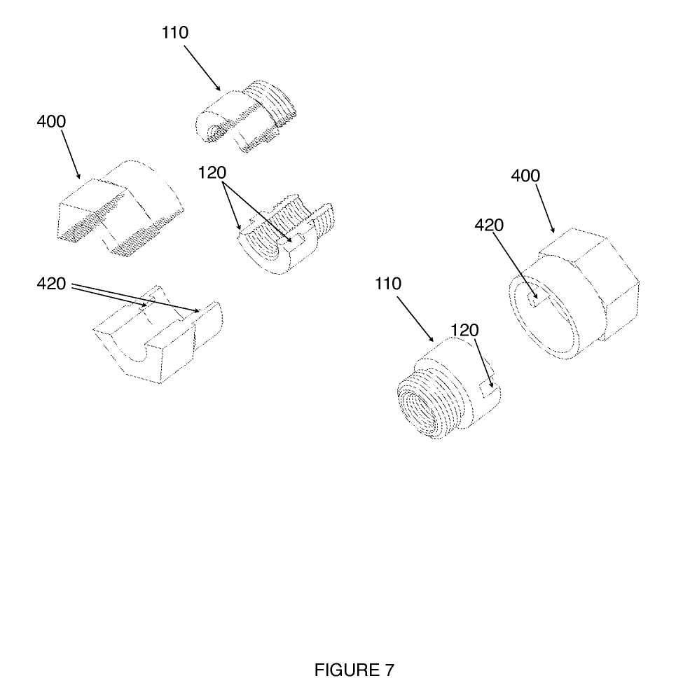

Referring to FIG. 7, an embodiment of the security device is shown wherein an embodiment of a key 400 and corresponding head 110 of a bolt are depicted at different angles and cutaways. Shown is a variation of at least one functional marker 120 on the head 110 of a bolt that is adapted to engage the at least one functional interaction points 420 of the key 400. As would be understood by those skilled in the art, the functional markers 120 and functional interaction points 420 could include any combination and/or quantity of grooves, indentions, pins, unique surface formations, etc. as long as the correct combination on the head 110 of a bolt functionally match with the respective key 400.

It is to be appreciated that the Detailed Description section, and not the Abstract section, is intended to be used to interpret the claims. The Abstract section may set forth one or more but not all exemplary embodiments of the present invention as contemplated by the inventor (s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A security device, comprising:
a. a bolt, comprising
i. a head, wherein said head comprises at least one functional marker; and
ii. a hollow cylinder, said hollow cylinder comprising a bolt internal threaded surface and a bolt external threaded surface, wherein said bolt internal threaded surface extends through said head; and
b. a nut, comprising
i. a first nut cylinder, wherein said first nut cylinder is internally grooved threaded and of said same diameter as said bolt external threaded surface; and
ii. a second nut cylinder, whereby said second nut cylinder is capable of containing said head of said bolt when said bolt external threaded surface is securely screwed into said first nut cylinder.

2. The security device of claim 1, wherein said at least one functional marker comprises one or more pins.

3. The security device of claim 1, wherein said at least one functional marker comprises one or more grooves.

4. The security device of claim 1, wherein said at least one functional marker comprises one or more grooves and one or more pins.

5. The security device of claim 1, further comprising a washer between said bolt and said nut when said bolt is fixably screwed into said nut.

6. The security device of claim 1, wherein said at least one functional interaction point is selected from the group consisting of, unique shape grooves, indentions, pins, and unique surface formations.

7. The security device of claim 1, wherein said internally grooved threaded surface is threaded in a counterclockwise fashion.

8. The security device of claim 1, further comprising a base and a cylindrical shaft, wherein said cylindrical shaft is threaded around its perimeter and fixably attached to said base, whereby said bolt internal threaded surface is capable of accepting said cylindrical shaft.

9. The security device of claim 5, further comprising a washer between said nut and said base when said bolt is fixably threaded onto said nut and said cylindrical shaft.

10. The security device of claim 1, further comprising a key, wherein said key comprises a receiving unit, wherein said receiving unit comprises at least one functional interaction point, whereby said at least one functional marker of said head of said bolt and said at least one functional interaction point of said key match up and allow for said key to engage said head.

11. A security device, comprising:
a. a bolt, said bolt further comprising at least one functional marker, and said bolt is externally threaded in reverse;
b. a nut, said nut internal grooves threaded in reverse; and
c. a key; wherein said key comprises a receiving unit, wherein said receiving unit comprises at least one functional interaction point, whereby said at least one functional marker of said head of said bolt and said at least one functional interaction point of said key match up and allow for said key to engage said head.

12. The security device of claim 11, wherein said at least one functional marker comprises one or more pins.

13. The security device of claim 11, wherein said at least one functional marker comprises one or more grooves.

14. The security device of claim 11, wherein said at least one functional marker comprises one or more grooves and one or more pins.

15. The security device of claim 11, further comprising a washer between said bolt and said nut when said bolt is fixably screwed into said nut.

16. The security device of claim 11, further comprising a base and a cylindrical shaft, wherein said cylindrical shaft is threaded around its perimeter and fixably attached to said base, whereby said bolt internal threaded surface is capable of accepting said cylindrical shaft.

17. The security device of claim 11, wherein said at least one functional interaction point is selected from the group consisting of, unique shape grooves, indentions, pins, and unique surface formations.

18. The security device of claim 11, wherein said key and said nut comprise a slanted, pyramid shaped cross-section.
